(19) United States
(12) Patent Application Publication
(10) Pub. No.: US 2015/0188414 A1
(43) Pub. Date: Jul. 2, 2015

(54) SINGLE-PHASE POWER FACTOR CORRECTOR WITH STEP-UP AND STEP-DOWN FUNCTIONS

(71) Applicant: ASIAN POWER DEVICES INC., Taoyuan County (TW)

(72) Inventors: Yu-Chi LAI, Taoyuan County (TW); Tsung-Liang HUNG, Taoyuan County (TW)

(21) Appl. No.: 14/464,666

(22) Filed: Aug. 20, 2014

(30) Foreign Application Priority Data
Dec. 31, 2013 (TW) 102149417

(51) Int. Cl. H02M 1/42; H02M 3/158; H02M 1/08; H02M 7/06

(52) U.S. Cl. CPC H02M 1/4208; H02M 7/06; H02M 3/1582; H02M 1/08

(57) ABSTRACT

A single-phase power factor corrector with step-up and step-down functions provides a step-up circuit and a step-down circuit which are connected in parallel to each other and thereby stabilizes an output voltage of the power factor corrector.

### BACKGROUND

1. Technical Field

The present disclosure relates generally to a single-phase power factor corrector, and more particularly to a single-phase power factor corrector with step-up and step-down functions is provided to stabilize the output voltage of the power factor corrector.

2. Description of Related Art

Reference is made to FIG. 1 which is a circuit diagram of a related-art step-up (boost) PFC system. The step-up (boost) PFC system includes a rectifying bridge and a step-up PFC circuit. The rectifying bridge is composed of four diodes, a first output terminal, and a second output terminal, and receives an AC input voltage Vin. The step-up PFC circuit has a switch S with a first terminal and a second terminal, an inductor L with a first terminal and a second terminal, a diode D with an anode and a cathode, and an output capacitor C with a first terminal and a second terminal, and outputs a DC voltage Vo. In particular, the first terminal of the switch S is coupled to the second terminal of inductor L and the anode of the diode D. The second terminal of the switch S is coupled to the second output terminal of the rectifying bridge and the second terminal of the output capacitor C. The first terminal of the inductor L is coupled to the first output terminal of the rectifying bridge. The first terminal of the output capacitor C is coupled to the cathode of the diode D. When the switch S is turned on, the inductor L is charged to store energy by the AC input voltage Vin. On the contrary, the AC input voltage Vin and the energy stored in the inductor L are provided to supply loads when the switch S is turned off.

Reference is made to FIG. 2 which is a circuit diagram of a related-art step-down (buck) PFC system. The step-down (buck) PFC system includes a rectifying bridge and a step-down PFC circuit. The rectifying bridge is composed of four diodes, a first output terminal, and a second output terminal, and receives an AC input voltage Vin. The step-down PFC circuit has a switch S with a first terminal and a second terminal, an inductor L with a first terminal and a second terminal, a diode D with an anode and a cathode, and an output capacitor C with a first terminal and a second terminal, and outputs a DC voltage Vo. The circuit connection of the step-down PFC circuit is different from that of the step-up PFC circuit, which is described as follows. The first terminal of the switch S is coupled to the first output terminal of the rectifying bridge. The second terminal of the switch S is coupled to the first terminal of the inductor L and the cathode of the diode D. The cathode of the diode is coupled to the second output terminal of the rectifying bridge and the second terminal of the output capacitor C. The second terminal of the inductor L is coupled to the first terminal of the output capacitor C. When the switch S is turned on, the inductor L is charged to store energy by the AC input voltage Vin and the AC input voltage Vin is provided to supply loads. On the contrary, the energy stored in the inductor L are provided to supply loads when the switch S is turned off.

For the step-up PFC circuit, the output voltage of the step-up PFC circuit is greater than the input voltage thereof, and which is typically about 400 volts. However, the 400-volt high voltage is not available for most electronic loads unless an isolated buck circuit or a regulating circuit is used. In addition, the voltage difference between the output voltage and the input voltage results in low efficiency under the low-input-voltage operation.

For the step-down PFC circuit, the total harmonic distortion (THD) and the power factor (PF) are less than those of the step-up PFC circuit. Also, it is more complicated in switch driving and current sensing of the step-down PFC circuit. In addition, the energy storing in the output capacitor (bulk capacitor) is lower because of the lower output voltage so that the larger buck capacitor is required but the hold-up time is reduced.

Accordingly, it is desirable to provide a single-phase power factor corrector with step-up and step-down functions to stabilize the output voltage of the power factor corrector.

### SUMMARY

An object of the present disclosure is to provide a single-phase power factor corrector with step-up and step-down functions to solve the above-mentioned problems. The power factor corrector includes a step-up circuit and a step-down circuit which are connected in parallel to each other and thereby stabilizes an output voltage of the power factor corrector. Accordingly, the single-phase power factor corrector with step-up and step-down functions is coupled to an input voltage terminal and an output voltage terminal, and the single-phase power factor corrector includes a step-up circuit, a step-down circuit, a judgment unit, and a processing unit. The step-up circuit is coupled to the input voltage terminal and the output voltage terminal, and steps up an input voltage at the input voltage terminal. The step-up circuit has a step-up unit and a first switch unit coupled to the step-up unit. The step-down circuit is coupled to the input voltage terminal and the output voltage terminal, and steps down the input voltage. The step-down circuit has a step-down unit and a second switch unit coupled to the step-down unit. The judgment unit is coupled to the input voltage terminal and the output voltage terminal, and compares the input voltage and an output voltage at the output voltage terminal and thereby generates a signal. The processing unit receives the signal generated from the judgment unit to control the step-up circuit and the step-down circuit.

In addition, the step-down circuit is coupled in parallel to the step-up circuit. The processing unit controls whether the step-up mode or the step-down mode is executed according to the signal generated from the judgment unit, thus stabilizing the output voltage at the output voltage terminal.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a circuit diagram of a related-art step-up (boost) PFC system;

FIG. 2 is a circuit diagram of a related-art step-down (buck) PFC system;

FIG. 3 is a circuit block diagram of a single-phase PFC with step-up and step-down functions according to the present disclosure;

FIG. 4 is a circuit diagram of a step-up unit in FIG. 3 according to the present disclosure;

FIG. 5 is a circuit diagram of a step-down unit in FIG. 3 according to the present disclosure;

FIG. 6 is a schematic view of comparing an output voltage to an input voltage according to a first embodiment of the present disclosure; and

FIG. 7 is a schematic view of comparing an output voltage to an input voltage according to a second embodiment of the present disclosure.

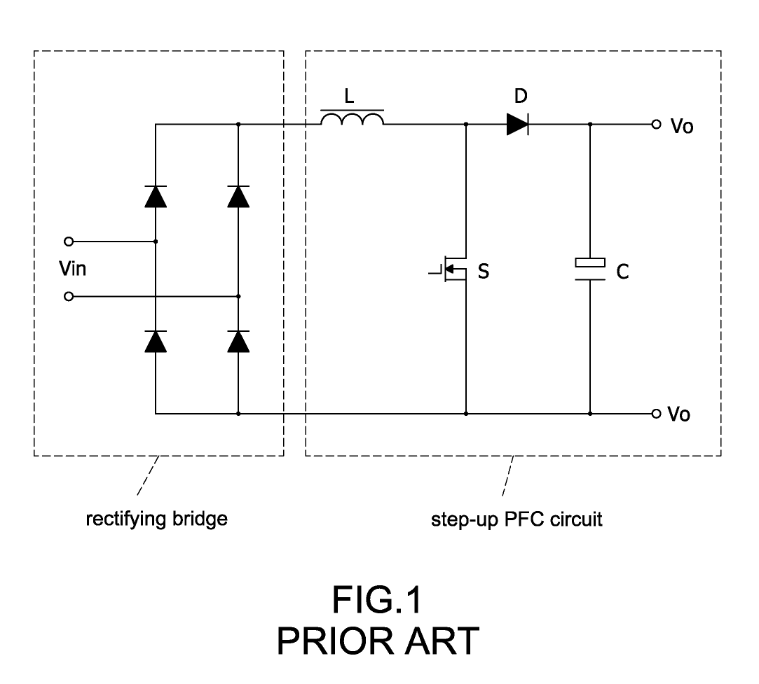

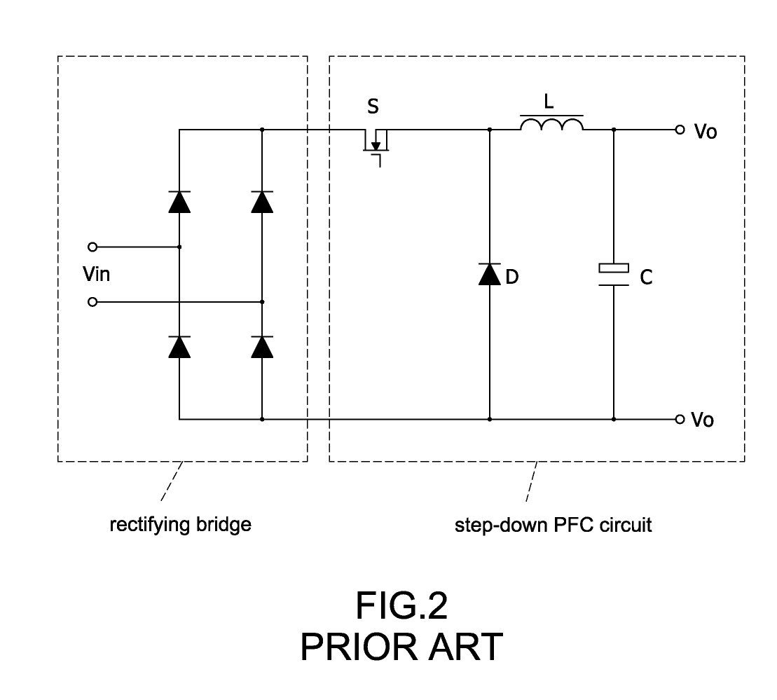

### DETAILED DESCRIPTION

Reference will now be made to the drawing figures to describe the present invention in detail.

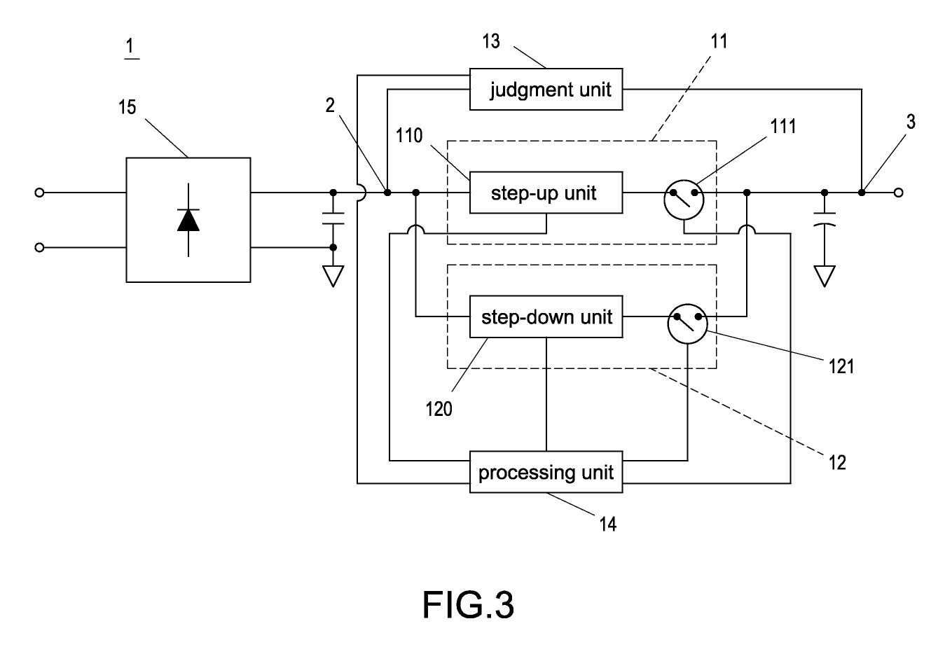

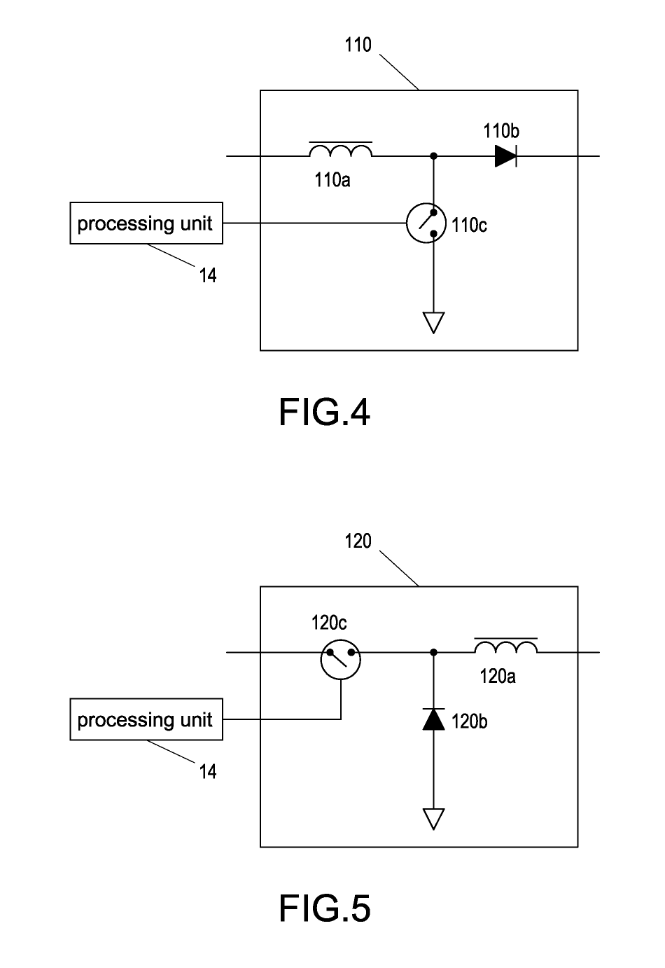

Reference is made from FIG. 3, FIG. 4, and FIG. 5 which are circuit diagrams of a single-phase power factor corrector with step-up and step-down functions according to preferred embodiments of the present disclosure. The single-phase power factor corrector 1 with step-up and step-down functions is coupled to an input voltage terminal 2 and an output voltage terminal 3. Especially, the term “step-up” is also referred to as “boost”, and the term “step-down” is also referred to as “buck”. The single-phase power factor corrector 1 includes a step-up circuit 11, a step-down circuit 12, a judgment unit 13, and a processing unit 14.

The step-up circuit 11 is coupled to the input voltage terminal 2 and the output voltage terminal 3 to step up a voltage at the input voltage terminal 2 of the step-up circuit 11. The step-up circuit 11 has a step-up unit 110 and a first switch unit 111 coupled to the step-up unit 110. The step-up unit 110 has an inductor element 110a with a first terminal and a second terminal, a diode 110b with an anode terminal and a cathode terminal, and a step-up switch element 110c with a first terminal and a second terminal. The second terminal of the inductor element 110a is coupled to the first terminal of the step-up switch element 110c and the anode terminal of the diode 110b. The first switch unit 111 is coupled to the first terminal of the inductor element 110a or the cathode terminal of the diode 110b. In this embodiment as shown in FIG. 3, the first switch unit 111 is coupled to the cathode terminal of the diode 110b.

The step-down circuit 12 is coupled to the input voltage terminal 2 and the output voltage terminal 3 to step down a voltage at the input voltage terminal 2 of the step-down circuit 12. The step-down circuit 12 is coupled in parallel to the step-up circuit 11. The step-down circuit 12 has a step-down unit 120 and a second switch unit 121 coupled to the step-down unit 120. The step-down unit 120 has an inductor element 120a with a first terminal and a second terminal, a diode 120b with an anode terminal and a cathode terminal, and a step-down switch element 120c with a first terminal and a second terminal. The first terminal of the inductor element 120a is coupled to the second terminal of the step-down switch element 120c and the cathode terminal of the diode 120b. The second switch unit 121 is coupled to the second terminal of the inductor element 120a or the first terminal of the step-down switch element 120c. In this embodiment as shown in FIG. 3, the second switch unit 121 is coupled to the second terminal of the inductor element 120a.

The judgment unit 13 is coupled to the input voltage terminal 2 and the output voltage terminal 3. The judgment unit 13 compares a voltage at the input voltage terminal 2 and a voltage at the output voltage terminal 3 and thereby generates a signal.

The processing unit 14 can be a processor, a microprocessor, or other equivalent elements. The processing unit 14 receives the signal generated from the judgment unit 13 to control the step-up circuit 11 and the step-down circuit 12. More specifically, the processing unit 14 can control the first switch unit 111 and the step-up switch element 110c of the step-up circuit 11, also the second switch unit 121 and the step-down switch element 120c of the step-down circuit 12. In particular, the first switch unit 111, the second switch unit 121, the step-up switch element 110c, and the step-down switch element 120c can be transistor components, such as MOSFETs, BJTs, or IGBTs, or other equivalent components.

The single-phase power factor corrector 1 further includes a rectifying circuit 15. The rectifying circuit 15 is coupled to the input voltage terminal 2 to rectify and convert the utility power and thereby provide the required power for rear-end circuits.

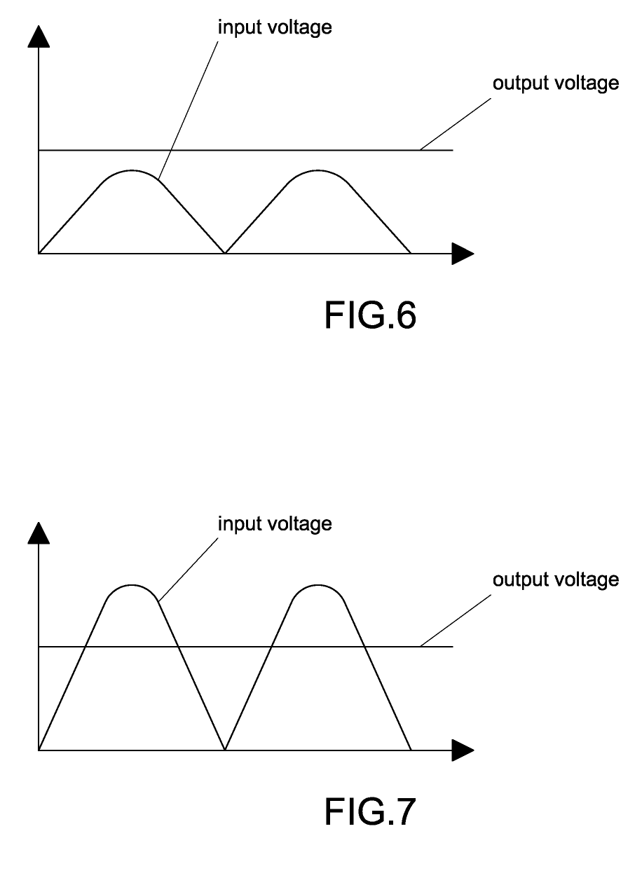

Reference is made to FIG. 6 which is a schematic view of comparing an output voltage at the output voltage terminal 3 to an input voltage at the input voltage terminal 2 according to a first embodiment of the present disclosure. When the judgment unit 13 judges that the input voltage at the input voltage terminal 2 is less than the voltage at the output voltage terminal 3, the judgment unit 13 generates a signal and thereby drives the processing unit 14 so that the first switch unit 111 and the step-up switch element 110c of the step-up unit 110 are turned on. On the contrary, the second switch unit 121 and the step-down switch element 120c of the step-down unit 120 are turned off. Accordingly, the single-phase power factor corrector 1 is operated under the step-up (boost) mode.

Reference is made to FIG. 7 which is a schematic view of comparing an output voltage at the output voltage terminal 3 to an input voltage at the input voltage terminal 2 according to a second embodiment of the present disclosure. When the judgment unit 13 judges that the input voltage at the input voltage terminal 2 is greater than the voltage at the output voltage terminal 3, the judgment unit 13 generates a signal and thereby drives the processing unit 14 so that the first switch unit 111 and the step-up switch element 110c of the step-up unit 110 are turned off. On the contrary, the second switch unit 121 and the step-down switch element 120c of the step-down unit 120 are turned on. Accordingly, the single-phase power factor corrector 1 is operated under the step-down (buck) mode. In conclusion, the processing unit 14 controls whether the step-up mode or the step-down mode is executed according to the signal generated from the judgment unit 13, thus stabilizing the output voltage at the output voltage terminal 3.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A single-phase power factor corrector with step-up and step-down functions coupled to an input voltage terminal and an output voltage terminal, the single-phase power factor corrector comprising:
a step-up circuit coupled to the input voltage terminal and the output voltage terminal and configured to step up an input voltage at the input voltage terminal, the step-up circuit having a step-up unit and a first switch unit coupled to the step-up unit;
a step-down circuit coupled to the input voltage terminal and the output voltage terminal and configured to step down the input voltage, the step-down circuit having a step-down unit and a second switch unit coupled to the step-down unit; wherein the step-down circuit is coupled in parallel to the step-up circuit;
a judgment unit coupled to the input voltage terminal and the output voltage terminal and configured to compare the input voltage and an output voltage at the output voltage terminal and thereby generate a signal; and
a processing unit configured to receive the signal generated from the judgment unit to control the step-up circuit and the step-down circuit.

2. The single-phase power factor corrector with step-up and step-down functions in claim 1, wherein the step-down unit and the second switch unit are turned on and the step-up unit and the first switch unit are turned off when the input voltage is greater than the output voltage; the step-down unit and the second switch unit are turned off and the step-up unit and the first switch unit are turned on when the input voltage is less than the output voltage.

3. The single-phase power factor corrector with step-up and step-down functions in claim 2, further comprising:
a rectifying circuit coupled to the input voltage terminal.

4. The single-phase power factor corrector with step-up and step-down functions in claim 3, wherein the step-up unit has an inductor element with a first terminal and a second terminal, a diode with an anode terminal and a cathode terminal, and a step-up switch element with a first terminal and a second terminal; the second terminal of the inductor element is coupled to the first terminal of the step-up switch element and the anode terminal of the diode; the first switch unit is coupled to the first terminal of the inductor element or the cathode terminal of the diode.

5. The single-phase power factor corrector with step-up and step-down functions in claim 4, wherein the step-down unit has an inductor element with a first terminal and a second terminal, a diode with an anode terminal and a cathode terminal, and a step-down switch element with a first terminal and a second terminal; the first terminal of the inductor element is coupled to the second terminal of the step-down switch element and the cathode terminal of the diode; the second switch unit is coupled to the second terminal of the inductor element or the first terminal of the step-down switch element.

6. The single-phase power factor corrector with step-up and step-down functions in claim 5, wherein the processing unit is a processor or a microprocessor.

7. The single-phase power factor corrector with step-up and step-down functions in claim 6, wherein the first switch unit, the second switch unit, the step-up switch element, and the step-down switch element are transistor components; and the transistor components are MOSFETs, BJTs, or IGBTs.
